(19) United States
(12) Patent Application Publication
(10) Pub. No.: US 2021/0319363 A1
(43) Pub. Date: Oct. 14, 2021

(54) METHOD AND SYSTEM FOR GENERATING ANNOTATED TRAINING DATA

(71) Applicant: Yield Systems Oy, Helsinki (FI)

(72) Inventors: Jussi Gillberg, Helsinki (FI); Harri Juntunen, Helsinki (FI); Paul Wagner, Helsinki (FI); Jarno Lintusaari, Helsinki (FI); Linh Nguyen, Helsinki (FI)

(73) Assignee: Yield Systems Oy, Helsinki (FI)

(21) Appl. No.: 17/268,163

(22) PCT Filed: Aug. 19, 2019
(86) PCT No.: PCT/FI2019/050589

§ 371 Date: Feb. 12, 2021

(30) Foreign Application Priority Data
Aug. 20, 2018 (FI) 20185687

(51) Int. Cl. G06N 20/00; G06N 5/04

(52) U.S. Cl. CPC G06N 20/00; G06N 5/04

(57) ABSTRACT

A method of generating an annotated synthetic training data for training a machine learning module for processing an operational data set includes creating a first procedural model for the object, the first procedural model having a first set of parameters relating to the object; creating a second procedural model for the background, the second procedural model having a second set of parameters relating to the background; creating the task environment model pertaining to the machine learning task using the first and the second procedural models; creating a synthetic data set using the task environment model; and allocating at least one parameter of the first set of parameters as an annotation for the simulation data to generate the annotated synthetic training data.

### TECHNICAL FIELD

The present disclosure relates generally to machine learning and artificial intelligence; and more specifically, to methods of generating an annotated synthetic training data for training a machine learning module for processing an operational data set. Furthermore, the present disclosure relates to systems for generating an annotated synthetic training data for training a machine learning module for processing an operational data set.

### BACKGROUND

In recent times, artificial intelligence has played a major role in technological advancement. Artificial intelligence has applications in almost every field of technology such as research, education, automation and so forth. Artificially intelligent tools require to be trained for providing applications in a specific field thereof. Such training of the artificially intelligent tools is performed by way of annotated or unannotated training data that are used by training algorithms.

Performance of machine learning systems is dependent on quantity and quality of the training data available for training thereof. Many machine learning systems require large amounts of data for providing reliable and accurate performance. The training data that is available for training often suffers from biases during data collection process. For example, the machine learning systems cannot be trained for rare scenarios in case of unavailability of training data for the specific scenario. The training data is often collected for some specific purpose. Hence, the training data may not be optimal for training the machine learning system for a new task. Moreover, currently available machine learning systems may not be able to optimize the training data as per requirement and changes in the machine learning task of interest. Additionally, many machine learning systems have limited control of the features that are used for classification, counting and so forth. For example, machine learning systems that use methods such as Convolutional Neural Networks, have minimal control over the selection of the attributes and features based on which the systems make their decisions. In an example of image classification, a classifier may learn to use regions and characteristics of images that are not related to the actual classification task due to correlations among the background and the object to be classified because in the limited training data, the object is mainly observed in such surroundings. Consequently, false positive classifications may arise in future cases when images containing similar surroundings but a different object are classified using the system.

Further in many current machine learning applications, an annotated training data set is needed to train the machine learning methods. For instance, for regression, in addition to the covariates used for making predictions for the target variable, an annotated training data set with measurements of the target variable is needed. In the case of image data, the target variables can consist of but are not limited to image labels (classification) and a partitioning of the image pixels according to different classes (segmentation). The classifications and the segmentation correspond to annotations, and before training an artificially intelligent method for the task, a human needs to perform annotation of some training data so that the computer can learn to perform the same task. Generating such annotated training data takes a long time and requires lots of resources.

Therefore, in light of the foregoing discussion, there exists a need to overcome the aforementioned drawbacks associated with training data availability to train artificially intelligent tools. This embodiment presents a technique that partially solves these problems related to training machine learning systems, when the training data collected from the real world is biased, insufficient or not available.

### SUMMARY

The present disclosure seeks to provide a method of generating an annotated synthetic training data for training a machine learning module for processing an operational data set. The present disclosure also seeks to provide a system for generating a plurality of annotated synthetic training data for training a machine learning module for processing an operational data set. The present disclosure seeks to provide a solution to the existing problem of lack of annotated data for training of learning algorithms. An aim of the present disclosure is to provide a solution that overcomes at least partially the problems encountered in prior art, and provides an efficient, accurate and robust way of generating annotated and labelled data.

In one aspect, an embodiment of the present disclosure provides a method of generating an annotated synthetic training data for training a machine learning module for processing an operational data set, the method comprising:

(i) creating a first procedural model for the object the first procedural model having a first set of parameters relating to the object;
(ii) creating a second procedural model for the background the second procedural model having a second set of parameters relating to the background;
(iii) creating a task environment model using the first and the second procedural models;
(iv) creating a synthetic data set using the task environment model;
(v) generating the annotated synthetic training data by allocating at least one parameter of the first set of parameters as an annotation for the synthetic data set
(vi) training the machine learning module using the annotated synthetic training data;
(vii) processing the operational data set using the trained machine learning module; and
(viii) evaluating the processed operational data set and optimising the annotated synthetic training data based on the evaluation.

In another aspect, an embodiment of the present disclosure provides a system for generating an annotated synthetic training data for training a machine learning module for processing an operational data set, the system comprising a server arrangement that is configured to:

(A) create a first procedural model for an object, the first procedural model having a first set of parameters relating to the object;
(B) create a second procedural model for a background, the second procedural model having a second set of parameters relating to the background;
(C) create a task environment model using the first and the second procedural models;
(D) create a synthetic data set using the task environment model; and
(E) generate the annotated synthetic training data by allocating at least one parameter of the first set of parameters as an annotation for the synthetic data set
(F) train a machine learning module using the annotated synthetic training data; and
(G) process an operational data set using the trained machine learning module.

Embodiments of the present disclosure substantially eliminate or at least partially address the aforementioned problems in the prior art, and enables an efficient, reliable and effective approach for creating annotated synthetic training data. The present disclosure seeks to provide a solution to the existing problems such as inefficient, time consuming and labour-intensive task of creating annotated training data.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B are schematic illustrations of a network environment wherein a system for generating an annotated synthetic training data for a machine learning task is implemented, in accordance with different embodiment of the present disclosure;

FIG. 2 illustrates steps of a method of generating an annotated synthetic training data for a machine learning task, in accordance with an embodiment of the present disclosure;

FIG. 3 is a schematic illustration of an exemplary representation of a task environment model employed for generating an annotated synthetic training data, in accordance with an embodiment of the present disclosure;

FIG. 4A and 4B illustrate steps of an exemplary implementation of a method of generating an annotated synthetic training data for a machine learning task, in accordance with an embodiment of the present disclosure;

FIG. 5A and 5B illustrate an example annotated synthetic training data items generated from a task environment model and

FIG. 6 is an illustrative example of steps, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, method of generating an annotated synthetic training data for training a machine learning module for processing an operational data set, the method comprising:

(i) creating a first procedural model for the object the first procedural model having a first set of parameters relating to the object;
(ii) creating a second procedural model for the background the second procedural model having a second set of parameters relating to the background;
(iii) creating a task environment model using the first and the second procedural models;
(iv) creating a synthetic data set using the task environment model;
(v) generating the annotated synthetic training data by allocating at least one parameter of the first set of parameters as an annotation for the synthetic data set;
(vi) training the machine learning module using the annotated synthetic training data;
(vii) processing the operational data set using the trained machine learning module; and
(viii) evaluating the processed operational data set and optimising the annotated synthetic training data based on the evaluation.

In another aspect, system for generating an annotated synthetic training data for training a machine learning module for processing an operational data set, the system comprising a server arrangement that is configured to:

(A) create a first procedural model for an object, the first procedural model having a first set of parameters relating to the object;
(B) create a second procedural model for a background, the second procedural model having a second set of parameters relating to the background;
(C) create a task environment model using the first and the second procedural models;
(D) create a synthetic data set using the task environment model;
(E) generate the annotated synthetic training data by allocating at least one parameter of the first set of parameters as an annotation for the synthetic data set
(F) train a machine learning module using the annotated synthetic training data; and
(G) process an operational data set using the trained machine learning module.

The present disclosure provides the method of generating an annotated synthetic training data for training a machine learning module for processing an operational data set. Specifically, the present disclosure provides a method for generating an unbiased annotated synthetic training data. Hence, the annotated synthetic training data provides sufficient training data for training of the machine learning module in the machine learning task to be used for processing an operational data set. The method disclosed herein provides an economical solution for generating annotated data for machine learning tasks. Notably, the method considers combinations of different parameters (including for example physical parameters and photographical parameters in the context of image processing) relating to the object and the background. Therefore, the method is operable to provide annotated synthetic training data for potentially every possible scenario that may arise in the operational data that will be processed with the machine learning module trained with the annotated synthetic training data. Hence, the method disclosed herein substantially eliminates a possibility of unavailability of annotated training data since the method generates annotated synthetic training data. Moreover, the method disclosed herein has a high accuracy and provides efficient annotated synthetic training data for all possible scenarios which can be synthesized for the machine learning task in comparison with the real-world annotated training data sets that often are biased due to data collecting process. Furthermore, the present disclosure provides the system for generating the annotated synthetic training data for training a machine learning module for a machine learning task. The annotated synthetic training data can be used for training the machine learning module for processing an operational data set when operating a machine learning system. The system disclosed herein is economical, robust and easy to implement. Also, the system can be easily implemented with existing hardware infrastructure, for example, a graphics processing unit (GPU) may be used for producing image data rapidly. According to an embodiment a simulator environment can be used to create a synthetic training data according to parameters, some of which corresponding to the annotation. This annotated synthetic training data can then be used to train the machine learning system and to avoid the task of manual human annotation.

Throughout the present disclosure, the term “annotated synthetic training data” relates to a set of data items, each data item being associated with (or comprising) scores, counts, labels, partitionings of images, identifiers, symbols, phrases or any other means of representing properties of the data items in the set of data. The data items of the annotated synthetic training data may comprise of images, audio, video, text, charts and so forth. For example, when a machine learning task to be performed is detecting from images of leaves the percentage of leaf surface coloured according to symptoms of some disease, the data items comprise of images of leaves and the annotation for each data item can be the “percentage of surface covered”. In such a case, the percentage covered with said colours is a parameter in the procedural model relating to the plant leaves, the object, and the data is generated according to this parameter. Specifically, the annotated synthetic training data provides a mark-up (namely, metadata, explanation, and the like) for the data items included in the set of data. Annotated training data is needed in training machine learning systems for applications in the fields of education, software engineering, artificial intelligence, computational biology, image processing, law, linguistic, digital phenotyping, among others. The annotated synthetic training data differs from (organic/human generated) annotated training data as the annotated synthetic training data is generated via a simulation process.

Throughout the present disclosure, the term “task environment model” used herein, relates to a procedural model of a setting that comprises entities including at least one object and a background relating to the object. Annotated synthetic training data are then generated by varying parameter values associated with the entities of the object and the background, generating a data item according to each parameter value combination and assigning the annotation with each generated data item. Therefore, the task environment model can generate a plurality of scenarios for occurrence of entities therein and a data item corresponding to each scenario can be created. In a first example, a given task environment model may be a 3D model of a railway station comprising a plurality of trains, a plurality of platforms, a foot-over bridge and a plurality of persons. Specifically, the plurality of trains, the plurality of platforms, the foot-over bridge and the plurality of persons may be considered as entities in the given environment. In a second example, a given task environment model may be a field used for agronomic purposes comprising crop plants grown in the field, the terrain on which plants grow (with a shape, colour and texture) and weeds (unwanted plants growing in the field). Specifically, the crop plants, the terrain on which plants grow and weeds may be considered as entities in the given environment.

Furthermore, the task environment model comprises the object and the background. Throughout the present disclosure, the term “object” described herein, relates to one or more entities of interest among the entities included in the task environment model that are related to the machine learning module/task. The machine learning module is trained and the trained machine learning module can be used for processing an operational data set. Such processing operations that are used for processing an operational data set may be identification, positioning, classification, counting, regression and so forth. It is to be understood that the operations are performed based on features (namely, properties) related to the object. Referring to the first example, the plurality of trains may be the object in the given example. Specifically, a counting operation may need to be performed on the plurality of trains. Notably, each of the entities in the task environment model excluding the object are considered as the background in the task environment model. Throughout the present disclosure, the term “background” refers to, each of the entities in the task environment model that occur in surroundings of the object (namely, entity of interest) within the task environment model. An orientation and other properties of entities in the background might affect the operations to be performed on the object. Indeed it is to be understood that the background in an input data affects an output of the machine learning module and hence it is important to train the machine learning module to perform the machine learning task with varying backgrounds. In a third example, the task environment model may be a street with buildings and trees in the background. Additionally, a car on the street may the object. Yet a fourth example, the task environment model might be a forest with different type of trees. A certain type of tree such as pine tree may be the object and the forest may be the background. In a fifth example, the machine learning task is to count the number of apples from images of real-world apple trees, the objects in the annotated synthetic data are the apples and the operation to perform is to compute their count in an image. In such a case, the background could be the other parts of the tree and other surroundings. In an example where the task environment model is a field used for agronomic purposes, the object could be the weeds, the crop plants and the terrain corresponding to the background. The machine learning task could be detecting and positioning the weeds from the field.

Optionally, the machine learning task may correspond to combinations of the operations.

The method comprises (i) creating the first procedural model for the object, the first procedural model having the first set of parameters relating to the object. The first procedural model is used for procedural data generation relating to the object. In other words, the first procedural model for the object relates to procedural simulation of the parts and features associated with the object in each data item of the annotated synthetic training data. Specifically, the first procedural model for the object relates to generation of the features (namely, attributes) of the data associated with the object. Such features are controlled by the first set of parameters relating to the object. Specifically, the data simulated from the first procedural model for the object is required for training the machine learning module to perform the machine learning task. The ability to create an arbitrary number of training samples with different feature combinations of the object enables achieving a high accuracy or success rate in general in performing operations on the object.

The method further comprises (ii) creating the second procedural model for the background, the second procedural model having the second set of parameters relating to the background. The second set of parameters controls a plurality of features (namely, attributes) associated with the entities in the task environment model that are associated with the background. Specifically, the values of the second set of parameters are varied to induce variations in the parts and features associated with the background in the annotated synthetic training data items. Specifically, the second procedural model for the background is used for the simulation of the parts of each data item related to the background. The features (attributes) of the background are controlled by the second set of parameters. Beneficially the ability to create an arbitrary number of annotated synthetic training data samples with different feature combinations of the background enables achieving a high accuracy or success rate in the machine learning task.

The method further comprises (iii) creating a task environment model that can synthesize inputs for the machine learning module for performing the machine learning task using the first and the second procedural models. The task environment model enables creating a collection of a plurality of scenarios comprising the object and the background, wherein each of the scenarios correspond to different parameter values for the object and the background. The task environment model is created by combining the first procedural model and the second procedural model. Beneficially, the task environment model can be used to simulate synthetic training data comprising a plurality of scenarios with varying values of parameters relating to the object and the background. Hence, the task environment model can provide required training data quickly and efficiently, that otherwise would have required a large amount of manual work and time.

It is to be understood that in the task environment model, the actual feature values of the data items generated from the task environment model relating to the object and the background may be affected by interactions between the object and the background. For example, when generating images of cars on a parking lot for training a machine learning module to locate cars from images, the surroundings of the car object, which is controlled by the second procedural model for the background, will affect the image pixels which are a part of the car object through reflections and shades. In this example, a building can cast a shadow on the car and result in different pixel values corresponding to an interaction between the object and the background. The object is still generated and controlled by the first procedural model whereas the background is generated and controlled by the second procedural model: without the first procedural model for the object, the object would not be present in the output of the task environment model and without the second procedural model for the background, there would be no background for the object.

Furthermore, the method comprises (iv) creating a synthetic data set using the task environment model. The synthetic data set is created by simulating items of training data according to varied combinations of parameter values relating to the object (the first set of parameters) and the background (the second set of parameters) in the task environment model. Notably, each of the items of the synthetic data set created using the task environment model comprises a specific unique combination of values of the parameters in the task environment model. Beneficially, the effects of different factors can be identified in the synthetic data set created from the task environment model as the first set of parameters relating to the object and the second set of parameters relating to the background can be set independently: in the synthetic data set, the features of the object can be made independent of the features of the background (unlike in operational data sets measured in the real world, which are often biased so that the background is correlated with the objects). The synthetic data set also provides training items for rare instances (for example, black swan events) that may not be available otherwise. Beneficially, synthetic data set provides training data for both frequently occurring and rare scenarios from the task environment model. An example of a black swan event may be an image of a terrorist with an explosive that is likely to never occur in video surveillance footage of a nuclear power plant. Referring to an example described above, synthetic data set may be created using the task environment model by varying features associated with the first set of parameters relating to the object (i.e.“the plurality of paintings”) and the second set of parameters relating to the background including wall of the art gallery, the showpieces therein and the plurality of visitors.

The method further comprises (v) generating the annotated synthetic data by allocating at least one parameter of the first set of parameters as an annotation for the synthetic data set to generate the annotated synthetic training data. The first set of parameters controls features (namely, attributes) relating to the object and the first set of parameters is used to create variation with respect to the object in the items of the synthetic data set. The synthetic data set is annotated with the values of one or more parameters selected as the annotation from the first set of parameters. Each of the items in the synthetic data is annotated with the corresponding values of the selected parameter used when generating the particular item. Referring to an example, the annotations may be features associated with the object “the plurality of paintings”. The annotations may be features like a position of the plurality of paintings, size of the plurality of paintings, shape of the plurality of paintings, content of the plurality of paintings and so forth.

According to an embodiment the annotated synthetic data comprises a first set of annotated synthetic data items, wherein each of the first set of annotated synthetic data items are generated by varying the value of at least one of a parameter among the first set of parameters or the second set of parameters and generating an output from the task environment model for each parameter value combination. Additionally according to an embodiment the annotated synthetic data might further comprise a second set of annotated synthetic data items, wherein each of the second set of annotated synthetic data items are generated by varying at least one of a parameter among the first set of parameters, the second set of parameters or a third set of parameters, wherein the third set of parameters relate to creating the synthetic data set from the task environment model and generating an output from the task environment model for each parameter value combination. As an example, the third set of parameters can control the point of view to the object and the background within the task environment model. This way annotated synthetic data can be formed for a fixed set of first parameters and a fixed set of second parameters from “different points of views” for example. To clarify, when the values of the third set of parameters are varied, the attributes of the object and the background can remain the same (for example the number of objects to be counted), however, the annotated training data items generated from the task environment model that are used as input to the machine learning module performing the machine learning task will be different with the different values of the third set of parameters.

The method further comprises (vi) training the machine learning module using the annotated synthetic training data. Notably, the machine learning module is an artificially intelligent learning technique. It is to be understood that the machine learning module can be trained to perform certain operations. Specifically, such training of the machine learning module is facilitated by use of the annotated synthetic training data, wherein the annotated synthetic training data provides examples of the input and output of the machine learning task to be performed with the entities (including the object and the background), and the synthetic training data can be simulated abundantly from the task environment model. Beneficially, training the machine learning module with abundant, unbiased training data enables a substantially improved accuracy and efficiency in operations performed by the machine learning module. It is important to understand that the annotation in this case, the parameters relating to the object, is used as specifications when generating the training data and hence the annotations for the annotated synthetic training data are known. Optionally, the features controlled with the first set of parameters may be the target variable of a regression model, when the machine learning task is regression.

The method further comprises (vii) processing an operational data set using the trained machine learning module. Specifically, operational data refers to real world data associated with real world environment. The machine learning task for which the machine learning module is trained for is to be performed on the operational data set, referred to as processing the operational data. The synthetic data set generated from the task environment model is used to train the machine learning module in a machine learning task. The trained machine learning module can then be used to process operational data, namely use the operational data as input to the machine learning module to obtain the output for the operational data. In the case of the art gallery example, the operational data consists of images from real art galleries and the machine learning task is to learn to position the paintings on the walls. In another example, the machine learning module is trained to count the number of cars in an image by using annotated synthetic training data. Then operational data, that is images taken from real world streets, is processed with the machine learning module: the images from the street are used as input to the machine learning module and the module then counts the numbers of cars in them.

Further machine learning task is related to processing the object while the annotation and the machine learning task may additionally involve the second and the third set of parameters. In example A, the machine learning task is to identify, if an image contains apples or oranges. In this case, the first procedural model related to the object is a 3d model for fruit and a parameter among the first set of parameters controls whether the generated fruit is an apple or an orange when generating samples of annotated training data. The background, which may simply be a blank white background or consist of images of leaves, is then controlled by the second set of parameters. In example B, the machine learning task is to detect the colour of the background surrounding the object (which may be an apple or orange). In example C, the machine learning task may be to estimate the angle, from which the image of the object has been taken from. Whereas the object (fruit) in examples A, B and C remains the same, the parameters that are used as the annotation and whose values are regressed in the machine learning task may yet be related to the first, second or third set of parameters.

The method further comprises evaluating an operational data set and optimizing the annotated synthetic training data based on the evaluation. Furthermore, the method comprises evaluating the performance of the machine learning module when used for processing an annotated operational data set and optimizing the annotated synthetic training data based on the evaluation of the performance. In the latter case, the operational data set is processed using the machine learning module and a performance score such as but not limited to accuracy is computed based on the provided annotation of the operational data set used for training and the output of the machine learning module. Then the performance score is used in modifying the task environment model or the parameter values used when generating the annotated synthetic training data to improve the performance score. In an example, the principle used in modifying the task environment model or the parameter values can be that when a change in the task environment model or the parameter values leads to improved performance measured in terms of the performance score, the change is beneficial for performance and should be kept. However, if performance suffers from the change, such changes are not beneficial and should be rejected. Therefore, the annotated synthetic training data is optimized based on the performance on the operational data set by making changes in the first procedural model for the object and the second procedural model for the background and the values of parameters for the different procedural models and optionally the third set of parameters based on the outcomes of such changes in the performance of the system. According to further optional embodiment, the machine learning module can be further trained based upon the set of operational data. Optionally, techniques such as Bayesian maximisation can be used for selecting the parameter values of the procedural models, from which the task environment model comprises of. Indeed, the present disclosure provides solution to form complex task environment models. As a further example the present disclosure enables to create and use 3D procedural models for both the object and the background. When creating 3D procedural models for complex cases requiring many parameters, the complexity of the model grows exponentially. As the number of parameters of the task environment model rises, the number of parameter value combinations and the number of synthetic data items representing the parameter combinations grows exponentially. For example, if each parameter has 5 different values and the number of different parameters relating to the object and the background is 15, the number of parameter combinations for which synthetic data items need to be created quickly becomes very large (5\hat{ }15). The developed method comprises adopting Bayesian maximization to manage the complexity of the optimization task. Based on tests the Bayesian maximization was found out clearly to outperform alternative optimization approaches, such as visual inspection and gradient based methods in the complex cases to which the current disclosure is providing a solution to. Indeed the use of the present Bayesian optimization approach has a measurable advantage as compared with alternative approaches. The provided way to process the operational data set and optimising the annotated synthetic training data based on the evaluation enables generation of synthetic training data for 3D models as well.

One specific advantage of using Bayesian maximization instead of other optimization approaches is that the impact of the parameters of the task environment model on the performance of the machine learning module is modelled with a surrogate model. With large numbers of parameters, a visual inspection is impossible and using of surrogate modelling automatically manages complexity. The surprising effect in this particular context comes from the intrinsic structure of the task environment model: surrogate modelling is surprisingly effective as natural constraints transferred into the structure of the task environment model benefit the surrogate approach speeding up the process of parameter selection.

Furthermore, when the number of parameters needed to a develop synthetic data set with sufficient variation is large annotated synthetic training data needs to be varied based on evaluation. Present disclosure is further related to a particular way of selecting the parameter combinations, for which synthetic data items are generated.

According to an additional or alternative embodiment, optimising the annotated synthetic training data based on the evaluation is done by using Bayesian maximisation. For brevity, the first, second and third sets of parameters are referred to as the parameters relating to the task environment model. The optimising of the annotated synthetic training data steps are described below

a) The task environment model is first created,
b) initial values for the parameters relating to the task environment model are selected,
c) annotated synthetic training data from the task environment model is created according to the parameter values related to the task environment model selected in step b) or l),
d) the machine learning module is trained using the annotated synthetic training data and the operational data set is processed using the trained machine learning module.

After this, evaluating the processed operational data set and optimising the annotated synthetic training data based on the evaluation comprises

e) selecting a surrogate model for modelling the impact of the parameters relating to the task environment model to the performance of the machine learning module on operational data (often a Gaussian Process) and
f) selecting an acquisition function for proposing new values of the parameters relating to the task environment model for generating annotated synthetic training data from the surrogate model
g) using cross validation or other performance evaluation techniques to evaluate the performance of the machine learning module on the operational data set
h) storing the sets of parameter values relating to the task environment model that were used for generating the annotated synthetic training data paired with the performance of the machine learning module on the operational data in computer storage
i) Based on the level of performance observed at stage h) and available computational resources, decide to either continue optimisation or to stop.

If the decision is to continue, continue to steps j, k, l. If decision is to stop, go to step m.

j) updating the parameters of the surrogate model according to the stored sets of parameter values relating to the task environment model that were used for generating the annotated synthetic training data and the corresponding performance of the machine learning module on the operational data
k) sampling a proposal for the values of the parameters relating to the task environment model by using the surrogate model and the acquisition function
l) performing step c) by using the proposed values for the parameters relating to the task environment model from step k) (instead of initial values) and then continue with steps d) then g), h),
m) If the decision is to stop, then train the machine learning module with annotated synthetic training data created according to the stored parameter values relating to the task environment model that give the best performance on the operational data when evaluated in step g) on the operational data.

The surrogate model predicts performance of the machine learning module on operational data from the values of the parameters relating to the task environment model used in generating the annotated synthetic data.

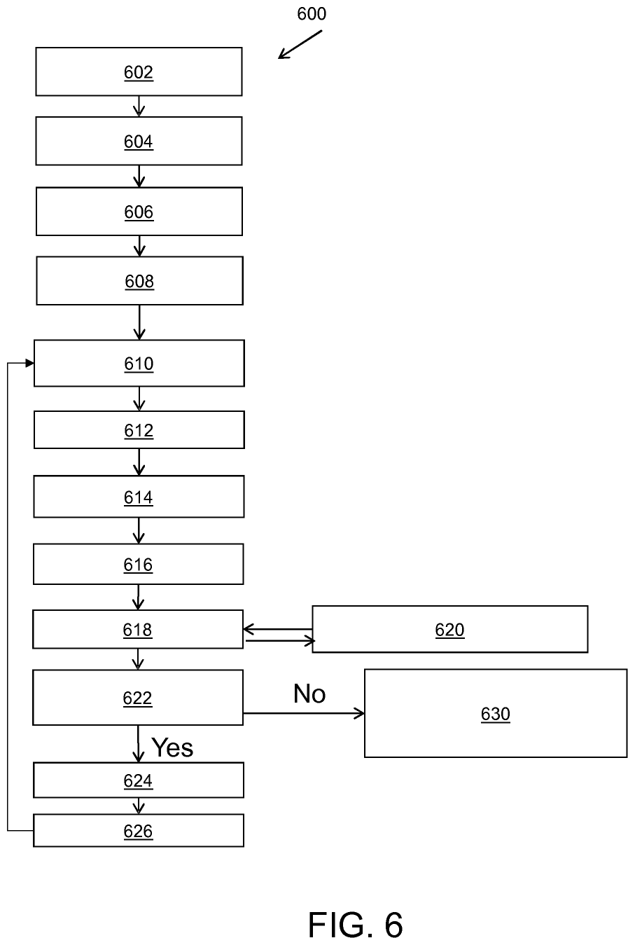

The steps of an embodiment of using Bayesian maximisation to select the values of parameters relating to the task environment model further illustrated in FIG. 6.

Optionally, processing the operational data set comprises performing at least one of but not limited to: classification, recognition, segmentation and regression. The machine learning module allows for processing the operational data: the operational data is used as input and the machine learning module generates an output based on the input. The machine learning module is operable to perform one or more tasks for which the machine learning module has been trained. Such tasks are required for a number of purposes such as education, research, image processing, healthcare and so forth. For example, image processing tasks arise in these and other fields. Example tasks in health care include classifying images of symptoms whereas in the field of plant breeding an example would be digital phenotyping. Furthermore, classification refers to categorization of entities based on one or more features associated therewith. Also, recognition relates to identification of one or more entities based on one or more features. Moreover, segmentation refers to division of certain parts of images based on entities therein and features associated therewith. Furthermore, regression refers to identification of dependencies between numeric scores and some covariates (namely features of the inputs of the machine learning module), the dependencies which can be linear or non-linear.

Optionally, the operational data set is processed for performing active sampling, performing fully automated tasks, control of measurement, control of effector and actuator devices and the like. Furthermore, active sampling refers to control of a device in operation such as controlling a camera while taking images, controlling a direction, motion and other factors of a drone in active state. Additionally, the operational data set is processed for performing fully automated tasks that comprise full robotic tasks that includes performing a complex human task like filling of pharmacy prescriptions, monitoring of an area and so forth. The operational data set is also processed for performing tasks like controlling the effector devices while interacting with real world object for example, while gardening, transporting items and so forth. Furthermore, the operational data set is also processed for performing tasks like controlling the actuator devices for controlling movement and actions of a device associated therewith.

In an example, an operation of segmentation may be performed for estimating an area of a leaf covered with disease symptom. In such an example, the task environment model is used to generate images of healthy and diseased leaves in varying backgrounds. The images can then be used for generating an annotated synthetic training data, where the value of the parameter controlling the surface area covered by the disease symptoms in the images is used as the annotation. Each image with its annotation corresponds to one item of the annotated training data. Notably, such annotated synthetic training data may be generated from a two-dimensional or three-dimensional model of a leaf with disease. The annotated synthetic training data may be used for training the learning module for performing segmentation of an image of a leaf into healthy segments and segments suffering from the disease.

In another example, an operation of object counting in an image may be performed for estimating a number of berries in images. Here, the output from the task environment model may be a plurality of images of bushes with berries therein. Specifically, the berries may be object and bushes may be background in the task environment model. Consequently, synthetic data set generated from the task environment model may be created according to varying parameter value combinations, the first set of parameters controlling for example the number, position, colour and shape of the berries. Similarly, procedural model for the background may be used to create the bushes in the images according to the values of the second set of parameters that control the size, position, colour and shape of the bushes. The procedural models for the object and the background may be two-dimensional or three-dimensional. Consequently, the annotated synthetic training data may be simulated from the task environment model by using the parameter value that controls the number of the berries as the annotation for each image generated according to varied parameter value combinations. The learning module may be trained using the plurality of annotated synthetic training data for counting the number of berries in the images. The images may be processed for counting the number of berries therein. In this example, the third set of parameters may be used to control the point of view, from which the images of the three-dimensional objects are generated from.

Optionally, the properties controlled by the first set of parameters relating to the object comprise at least one of: a position in the task environment model, an orientation of the object in the task environment model, a shape of the object, a colour of the object, a size of the object, a texture of the object. The first set of parameters can be used to control for example physical properties associated with the object in the task environment model. Herein, the parameter values controlling the physical properties associated with the object are varied in order to obtain annotated training data items for a number of possible scenarios, wherein the machine learning module can be trained to perform the machine learning task with the outputs of the task environment model and the annotations. In an example, the task environment model may be a 3D model of an art gallery displaying a plurality of paintings. In the art gallery, the plurality of paintings may be hanging on the wall, a plurality of showpieces may be arranged to decorate the art gallery, and further a plurality of visitors may be roaming around therein. In such an environment, the plurality of paintings may be the object, and the walls of the art gallery, the showpieces therein and the plurality of visitors may be the background. The first set of parameters related to the object, namely “the plurality of paintings” may include position and orientation of the plurality of paintings within the art gallery, colour and texture of the plurality of paintings as well as a shape of frames of the plurality of paintings. Further optionally, the first set of parameters relating to the object comprises a relation between objects in the task environment model, structure of the object in the task environment model and dynamics of the object in the task environment model.

Optionally, the second set of parameters relating to the background comprises at least one of: elements in the background, a position of the elements in the background, an orientation of the elements in the background, a shape of the elements in the background, a colour of the elements, a size of the elements, a texture of the elements. The second set of parameters controls for example physical properties associated with the entities in the background in the task environment model. Specifically, parameter values associated with these physical properties associated with the entities in the background are varied in order to create annotated synthetic training data from different scenarios, expressed by the values of the second set of parameters controlling the physical properties of the background. Referring to the third example described above, the walls of the art gallery, the showpieces therein and the plurality of visitors may be entities in the background. The second set of parameters related to the entities in the background may be position and orientation thereof within the art gallery or with respect to the object, colour and texture of the entities in the background as well as a shape of the showpieces. In such an example, the values of the second set of parameters may be varied (such as position and orientation of the showpieces may be changed) to create variation in the images generated by the task environment model.

Optionally, the properties of the background controlled by the second set of parameters comprises a relation between one or more elements in the background of the task environment model, structure of the one or more elements in the background of the task environment model, and dynamics of the one or more elements in the background of the task environment model.

Annotated synthetic training data items contain features related to the object and the background. The parts of the items related to the object are generated from the first procedural model and the parts of the items related to the background are generated from the second procedural model. In an example, the samples of the annotated synthetic training data are images. The machine learning task is to count the number of seeds in the spike of a wheat plant. The spike is generated from the first procedural model. The other content of each image, consisting of leaves, soil surface, straws and weeds is generated from the second procedural model for the background. Optionally, there may be interactions in the features of the object and the background in the synthetic data. In the current example, the colour of the background affects the parts of the images related to the seeds due to reflections.

Optionally a third set of parameters relating to creating the synthetic data set from the task environment model comprises at least one of: point of view, illumination level, zoom level, camera settings. The third set of parameters can be for example used to define the distance between the object in the task environment model and the viewing point when generating a synthetic data set comprising of images and annotations. In other example the third set of parameters is used to control the point of view and the ambient lighting conditions when creating images of the entities of the object and the entities of the background in the task environment model. Outputted images can be used as a synthetic dataset. The third parameter (first and/or second as well) can be used as annotations for the created images (i.e. the annotated synthetic dataset).

Optionally, the parameter values for the first, second and/or third set of parameters are selected based on at least one of: principles optimal design of experiments (namely, experimental design). Optimal design of experiments relates to creating such design matrices that allow the efficient estimation of the statistical effects related to each factor varied in the experiment. In optimal design of experiments, instead of creating every combination of the possible values of different factors, a smaller number of factor value combinations can be used such that a selected set of effects can still be estimated. It is to be understood that, several techniques (for example, alpha designs, beta designs, randomized designs and so forth) of experimental design can be used for selecting the combinations of values of the first, second and third set of parameters, according to which annotated training samples are generated from the task environment model. It is to be understood that not all possible parameter values associated with the object and the background need to be evaluated when creating set of training data for a particular machine learning task. Specifically, combinations of parameter values that correspond to orthogonal designs i.e. which are uncorrelated and independent of each other, can be selected for generating the annotated synthetic training data. Notably, the parameter value combinations can be selected based on one or more principles of optimal design of experiments. More optionally, random values can be used for generating data from the task environment model. More optionally, lists of possible values can be selected for all parameters and all combinations of parameter values can be used for data generation.

Optionally, at least one of a parameter from among the first set of parameters and the second set of parameters is varied in order to induce variation in at least one of: the object, the background. Notably, values associated with the second set of parameters are varied in order to induce variations in the background in the task environment model. Referring to the second example described above, the first set of parameters (such as position and orientation of the plurality of paintings) may be varied to induce changes in the object. That is, parameters associated with entities in the background may be varied with respect to the plurality of paintings in the art gallery.

More optionally, values associated with the second set of parameters are varied with respect to other entities in the background. Referring to the third example described above, position and orientation of the showpieces in the art gallery may be changed depending upon position and orientation of walls in the art gallery.

Optionally, the procedural model for the object may generate a plurality of entities. Optionally, the values of the first set of parameters associated with the features of an entity that is a part of the object are varied with respect to the values of the parameters of the other object entities in the task environment model (at an instance when more than one object entities are present in the task environment model). Again, referring to the second example, a distance between the plurality of paintings may be increased. Also, a rectangular frame of one of the plurality of paintings may be positioned adjacent to a square frame of one of the plurality of paintings.

More optionally, the values of the first set of parameters are varied with respect to entities in the background and the corresponding values of the second set of parameters. Again, referring to the second example, position and orientation of the plurality of paintings may be changed with respect to a position of the showpieces in the art gallery.

Optionally, the method includes creating a third procedural model. The third procedural model is created for varying and analysing different properties relating to the object and the background than those controlled by the first and the second procedural models. The properties controlled by the third procedural model may be related to lighting, probing the task environment model using ultraviolet rays (UV), infrared rays, X-ray, ultrasonic waves and so forth. Optionally, a set of parameters of the third procedural model includes one or more of position of the object, position of the elements in the background, orientation of the object, orientation of the elements in the background, shape of the object, shape of the elements in the background, colour of the object, colour of the elements in the background, size of the object, size of the elements in the background, texture of the object, texture of the elements in the background, structure of the object, structure of the elements in the background, dynamics of the object, dynamics of the elements in the background, relation between one or more object when there are a plurality of objects present in the task environment model and relation between the elements in the background. Consequently, the task environment model can be optionally created based upon the first procedural model for the object, the second procedural model for the background and the third procedural model. Creation of alternative/optional the task environment model based on the first procedural model, the second procedural model and the third procedural model might provide a more versatile and efficient training data if the features controlled by the first and second procedural models are not sufficient for a given machine learning task.

Optionally, synthetic data set is created by a simulator (for example, a game engine). Notably, the simulator is a machine that is configured to provide a realistic imitation of the real world and the simulator can be used to output items of synthetic data from the task environment model while varying the first set of parameters relating to the object in the task environment model and the second set of parameters relating to the background in the task environment model and optionally the third set of parameters. For example, a game engine can generate photorealistic images given 3D models for different entities and the assumptions about the properties and position of a light source in the 3D model. The simulator can be implanted using for example graphic processors units or similar high performance systems and programming. A simulator for sound based tasks can be implemented with a sound card and programming. Further optionally the allocated at least one parameter as an annotation originates from a metadata associated with the object. The metadata can be provided for the object for example when creating the first procedural model using graphics processing. As one example of this is to form the object as a graphical 3D object and allocated for the object a metadata parameter. The metadata parameter for the object can be for example type of the object (such as the object is a seed or leaf). This way during the training of the machine learning module the metadata can be used in an automatic way without manual annotations.

Optionally, the annotated synthetic training data comprises a set of annotated synthetic training data items, wherein each of the annotated synthetic training data items are generated by varying at least one of a parameter among the first set of parameters or the second set of parameters. Each of the annotated synthetic training data items exhibit a unique scenario corresponding to a parameter value combination relating to the object and the background. In each of the unique scenarios one or more values of parameters relating to the object and/or the background is varied. In an example, the object may comprise people present in a room and the background may include chairs, bed, a painting on a wall of the room and a table. In such an example, the set of annotated synthetic training data items may be created by changing one or more parameters associated with the object, such as a position associated with the people in the room, then synthesizing data items according to the parameter combinations and storing the data items and the values of the position parameters as the annotation related to each of the synthesized data items. Furthermore, the set of annotated synthetic training data items may be created by changing one or more parameter values relating to the background, such as position of chairs in the room, number of chairs in the room, position of the painting in the room and so forth, and storing the synthesized data items and the parameter values that are used as the annotation. Furthermore, the parameters relating to the object and the parameters relating to the background may be changed simultaneously to create the set of annotated synthetic training data items. According to an embodiment the values for the parameters can be set based on systematic rules (chaining one by one etc.), randomly, using a selected optimization algorithm, using machine learning algorithms, manually, using look up table, etc.

Optionally, given that a simulator for a physical or other phenomenon is available, the task environment model can be constructed based on such a simulator. The values of the parameters of the first and second set of parameters can be taken from historical data regarding the phenomenon or from an operational data set measured about the phenomenon. As an example, a speech synthesizer can be used as the procedural model for the object and random sound simulators can be used to create a background. In such a case, the parameters of the task environment model controlling the output and which are used as the annotation can be text of the speech audio data to be generated. In such a case, existing texts of littered speeches can be used as the parameter values and the annotation.

Optionally, the machine learning module is trained based upon a combination of the plurality of annotated synthetic training data and a set of operational data. The plurality of annotated synthetic training data and the set of operational data may be combined using learning techniques such as multi-task learning, multi-view learning, transfer learning, pre-training and so forth. Specifically in the context of this disclosure, multi-task learning performs classification, regression, segmentation tasks by simultaneously modelling the operational data and synthetic data set with distinct machine learning models, while sharing some parameters among those machine learning models for real and synthetic data set. Furthermore, multi-view learning uses different generative models for the operational data and synthetic data set and share some parameters therebetween the machine learning models. Moreover, pre-training trains a neural network with synthetic data set, and then re-trains some part of the machine learning model parameters with the operational data.

Optionally, the machine learning module is trained using the annotated synthetic training data and the operational data set simultaneously. The machine learning module is trained using a combination of the annotated synthetic training data and the operational data set. The combination of the annotated synthetic training data and the operational data set allows for an efficient training of the machine learning module.

Optionally, the machine learning module is trained using the annotated synthetic training data and the operational data set sequentially. For example, the machine learning module is first trained with the annotated synthetic training data and then the machine learning module is trained further with the operational data set. Alternatively, the machine learning module is first trained with the operational data set and then the machine learning module is further trained with the annotated synthetic training data.

Optionally, evaluating the performance of the machine learning module when processing the operational data set is used for optimizing the procedural models and the values of their parameters used in the generation of the annotated synthetic training data. Herein, creation of the annotated synthetic training data is also optimized to enable accurate processing of operational data with the machine learning module. Bayesian maximisation is one of the techniques that can be used to optimize the values of the first, second and optionally third sets of parameters to achieve better performance on the operational data.

Optionally, all the data items of the operational data set may not be available yet at the time of first evaluating the performance of the trained machine learning module on operational data in order to optimise the task environment model. The operational data set may accumulate over time and the machine learning module can be used to process data items that were not available when the operational data set was first used for optimising the task environment model.

Optionally, the annotated synthetic training data is optimized and brought closer to the operational data set by applying at least one machine learning method such as Generative Adversarial Networks or any other supervised or unsupervised machine learning techniques. Specifically, Generative Adversarial Networks is a deep neural network that is able to mimic any distribution of data based on an unsupervised learning method.

Optionally, the machine learning methods used for optimizing and bringing the annotated synthetic training data closer to the operational data set are designed in a way to learn only similar aspects of the annotated synthetic training data and the operational data set. Furthermore, the machine learning module can be designed in a way to prevent it from learning aspects of the annotated synthetic training data that differ from the operational data set. Additionally, such learning is achieved by applying suitable regularization methods or for example by removing the parts of the synthetic data that differ from their correspondents in the operational data so that the machine learning module cannot use them for the machine learning task.

Optionally, operational data may be used to optimize the values of the parameters of the task environment model by performing model selection for the values of the parameters of the task environment model. For example, the model selection technique of cross validation may be used. In this example, cross validation can be used to select parameter values of the task environment model, parameter values which maximise performance of the trained machine learning module on a test/validation set, the test/validation set comprising of operational data. Also, several alternative task environment models can be created and model selection techniques may be used for example but not limited to select one of the different task environment models or to find a weighting for the different task environment models. Notably, a learning algorithm, such as Bayesian maximization and the like may be used to determine parameter values used in simulating synthetic data from the task environment model, which values are the values of the first, second and third set of parameters, in addition to the machine learning model parameters.

In an exemplary implementation of the method, the machine learning task may be positioning of an object in an environment. The task environment model may include a parking lot, wherein a location of a vehicle is to be identified. Furthermore, a first set of parameters relating to the object “the vehicle” is defined and a second set of parameters relating to background “surroundings of the object” is defined. Subsequently, a first three-dimensional procedural model for the object is created and the output of the first procedural model is controlled by the first set of parameters relating to the object. Also, a second three-dimensional procedural model for the background is created and the output of the second procedural model is controlled by the second set of parameters relating to the background. Beneficially, when the three-dimensional procedural model of the object and the three-dimensional procedural model of the background are combined in the task environment model, arbitrarily large annotated synthetic training data set can be simulated by using a game engine that outputs the set of training data as a set of images from the task environment model comprising the two 3d models, the images portraying the vehicle at different positions under varying lighting conditions (and the resulting shadows), displaying the vehicle from varying imaging angles and also blocking the object with partial views. In this example, the location is one of the parameters in the first set of parameters according to which the data was generated and thus known for each image and the value of the location parameter is used as the annotation to create the annotated synthetic data set. Subsequently, a plurality of annotated synthetic training data may be simulated from the task environment model. Specifically, principles of design of experiments, that is optimal design of experiments, may be used to produce minimal sets of images that allow learning the machine learning task of regressing the coordinates of cars in the parking lot (output) from the image data (input). Subsequently, the operational data consisting of sets of images may be processed for locating the vehicle parked in the parking lot.

As an example, photogrammetry may be used to automatically construct components to be used by the procedural models in the case of producing image data from 3D models. Furthermore, three-dimensional (3D) components created by using photogrammetry can then be included in the procedural models to create synthetic data. Specifically, photogrammetry may be used for generating three-dimensional (3D) models with textures, shapes and attributes from physical objects to be used in the procedural models. For example, several samples of the texture and colour of asphalt can be obtained with photogrammetry and variations of parking lots can then be generated by using these samples.

In another example, the annotated synthetic training data may be generated for training the machine learning module for classifying fruits in two classes namely, apples and peers. In the synthetic data, images of apples and pears from random angles may be generated. The image is created at a specific random angle and the machine learning task is to label the images based on partial observation thereof. The annotated synthetic training data may be generated by labelling the fruits in different classes according to the used parameters: when an apple is generated, the label is “apple”. Further parameters of the procedural models may control shape of the fruit, size of the fruit, colour of the fruit and so forth.

In yet another example, the method may acquire text data and subsequently use speech synthesizer for creating the annotated synthetic training data thereof. The text used as the basis of generating the speech data with the synthesizer is used as the annotation and the sound data as other input data for the machine learning module. Also, different environmental noises, such as sounds of cars or music can be generated as the background. Consequently, the machine learning module may be trained with the annotated synthetic training data. Specifically, the machine learning module may be trained for matching text and different variations of voices. After training a machine learning module with such training data, the machine learning method may then be used for processing operational data: based on a speech recording, the machine learning method outputs text corresponding to the speech recording.

In an example, the method may acquire music scores and subsequently use a music synthesizer to synthesize sound data from the acquired music scores, the combination of the music scores (used as the annotation parameters, according to which the data is synthesized) and the sound data comprising an annotated synthetic data set. Consequently, the machine learning module may be trained with the annotated synthetic training data. Specifically, the machine learning module may be trained for matching the sound and the music scores. Such a machine learning module can then be used to output music scores from sound data.

Optionally, the method can be used to validate decision making in the task environment model. For example, a robot may be trained to move in the task environment model, the task environment model which may be dynamic or static. In such a case, the decision making of the robot is controlled by the machine learning module and outcomes of the decision may be evaluated in the simulator and used as annotation. For example, the task environment model may be a 3-dimensional physical and visual model of an environment where the robot should learn to operate. The machine learning task may be to “move from point A to point B without hitting any obstacles within the simulated environment”. The annotation may be “success” or “failure” and the inputs of the sensors of the robot during movement can be simulated based on the simulated events that result from the simulated movement of the robot according to decision making of the robot that is based on the machine learning module. When the robot runs into obstacles in the simulated environment, the result will be considered a failure. In this case, one parameter combination of the first and second sets of parameters that is used to generate the synthetic data may be used several times to get several repetitions for training the robot and several data points with different annotations for the same parameter values of the first and second sets of parameters.

The present disclosure also relates to the system as described above.

Various embodiments and variants disclosed above apply mutatis mutandis to the system.

Furthermore, the server arrangement is further configured to:

(F) train a machine learning module using the annotated synthetic training data; and
(G) process an operational data set using the trained machine learning module.

More optionally, the server arrangement is further configured to evaluate operational data and the performance of the trained machine learning module on operational data and to optimise the annotated synthetic training data based on the evaluation.

Optionally, wherein the server arrangement is further configured to train the machine learning module based upon a combination of the annotated synthetic training data and a set of operational data.

Optionally, processing the operational data set comprises performing at least one of machine learning tasks such as: classification, recognition, segmentation, object detection and regression.

Optionally, the server arrangement is further configured to create at least one of the first procedural model for the object and the second procedural model for the background

Optionally, the combinations of parameter values from which synthetic data is created are based on at least one principle of optimal design of experiments.

Optionally the server arrangement is further configured to select the values of the parameters of at least one of the first procedural model for the object and the second procedural model for the background based on at least one principle of design of experiments.

More optionally, at least one of a parameter from among the first set of parameters and the second set of parameters is varied and synthetic data items are created according to parameter values controlling the procedural model of at least one of: the object and the background.

Optionally, building blocks such as textures, shapes, sounds for the procedural models may be captured and/or identified by means of a user device. Throughout the present disclosure, the term “user device” relates to, an electronic device capable of sensing different parameters relating to the object and the background. The user device may be capable of capturing images of the object and background to be used in the task environment model, measuring size of the object and entities in the background, identifying shape of the object and entities in the background and producing 3D models to be used in the procedural models for the object and the background. Optionally, the user device may be communicably coupled to a database arrangement. Examples of the user devices include, but are not limited to, camera, mobile phones, smart telephones, Mobile Internet Devices (MIDs), tablet computers, Ultra-Mobile Personal Computers (UMPCs), tablet computers, Personal Digital Assistants (PDAs), web pads, Personal Computers (PCs), handheld PCs, laptop computers, and desktop computers.

Furthermore, throughout the present disclosure, the term “database arrangement” relates to, an arrangement of at least one database that when employed is operable to store the first set of parameters, the second set of parameters, the annotated synthetic training data and optionally the third set of parameters. The term “database” generally refers to hardware, software, firmware, or a combination of these, that is operable to provide storage functionality for storing the first set of parameters, the second set of parameters and the annotated synthetic training data and optionally the third set of parameters. Notably, the database arrangement allows for storing information associated with the first set of parameters, the second set of parameters and the annotated synthetic training data in an organized (namely, structured) manner, thereby, allowing for easy storage, access (namely, retrieval), updating and analysis of such entities. The database arrangement may be communicably coupled to the server arrangement.

Furthermore, the term “server arrangement” relates to, an arrangement of at least one data processing resource (for example, such as data processors) that, when operated, provides processing functionality for performing steps of the method of generating the annotated synthetic training data for the machine learning task. Furthermore, the server arrangement relates to a structure and/or module that include programmable and/or non-programmable components configured to store, process and/or share information. In an example, the server arrangement includes any arrangement of physical or virtual computational entities capable of enhancing information to perform various computational tasks. Furthermore, it will be appreciated that the server arrangement may be single hardware server and/or plurality of hardware servers operating in a parallel or distributed architecture. In an example, the server may include components such as memory, a processor, a network adapter and the like, to store, process and/or share information with other computing components, such as user device/user equipment. Optionally, the server arrangement is implemented as a computer program that provides various services (such as database service) to other devices, modules or apparatus. Optionally, the server arrangement is operably coupled to a communication network. It will be appreciated that a communication network can be an individual network, or a collection of individual networks that are interconnected with each other to function as a single large network. The communication network may be wired, wireless, or a combination thereof. Examples of the individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, radio networks, telecommunication networks, and Worldwide Interoperability for Microwave Access (WiMAX) networks. Beneficially, the network environment is easy to implement and can be easily integrated in existing hardware infrastructure. Also, the network environment is adaptable to technical changes related to hardware infrastructure employed therein. In other words, the network infrastructure is dynamically reconfigurable. Therefore, the network infrastructure can be easily integrated into existing hardware infrastructure. The communication network is operable to couple the database arrangement to the server arrangement. Server arrangement might comprise graphical processing units for generating a synthetic data set comprising of images.

For illustration purposes only, there will now be considered an exemplary network environment, wherein method of creating the annotated synthetic training data is implemented pursuant to embodiments of the present disclosure. The exemplary network environment may include one or more user devices that are coupled in communication with the server arrangement, via a communication network. Also, the exemplary network environment may include database arrangement for storing the procedural model for the object, procedural model for the background, the task environment model and other information required for implementing the method of generating the annotated synthetic training data.

Optionally, the annotated synthetic training data comprises a set of annotated synthetic training data items, wherein each of the annotated synthetic training data items are generated by varying at least one of a parameter among the first set of parameters or the second set of parameters and synthesizing a data item from the task environment model according to the selected parameter values and assigning the value of at least one parameter as the annotation.

Optionally, the models for the object and background may create video output, which enables creating annotated synthetic training data for machine learning tasks which are performed with video data. Such processing tasks include, for example, detection of movement, tracking of objects and monitoring of growth. In the example, the annotation could be the growth speed or other change that occurs over time. For example, the type of the change and speed of change can then be parameters of the procedural models and annotated synthetic training data can be simulated and the machine learning module trained with the annotated synthetic training data. The trained machine learning module can be used to process operational data, for example to regress growth speed.

Optionally the procedural models can be created for example by programming. In this case, the programmer defines a model and how the parameters affect the properties of the output of the model. Optionally, components for the procedural model can be created by using for example fotogrammetry and those components can be used as a part of a model created by programming. For example, fotogrammetry can be used to obtain the texture of an object and that texture can then be used as the surface of other 3D models that were otherwise created by programming.

Optionally the allocated annotation for the synthetic data set is a metadata associated with created a first procedural model for an object and the created first procedural model for the object is 3D graphical object.

Further optionally the system is arranged to communicate the results of processing the operational data with the machine learning module as a visual output or via an communication interface. Visual output can refer to video or still images as an example. The communication interface can be for example Internet connection (wired or wireless). Furthermore example of the results can be for example classification, recognition, segmentation, object detection and regression.

Optionally, parts of the procedural models used for sound generation can be obtained by recording sound samples. The user can then program a simulator that combines and/or modifies the recorded sound samples and possibly further combines them with completely programmed sound samples.

Optionally, the synthetic data set can be used for training machine learning modules for unsupervised machine learning tasks, in which the annotations of the training data are not used by the machine learning module.

### DETAILED DESCRIPTION OF THE DRAWINGS

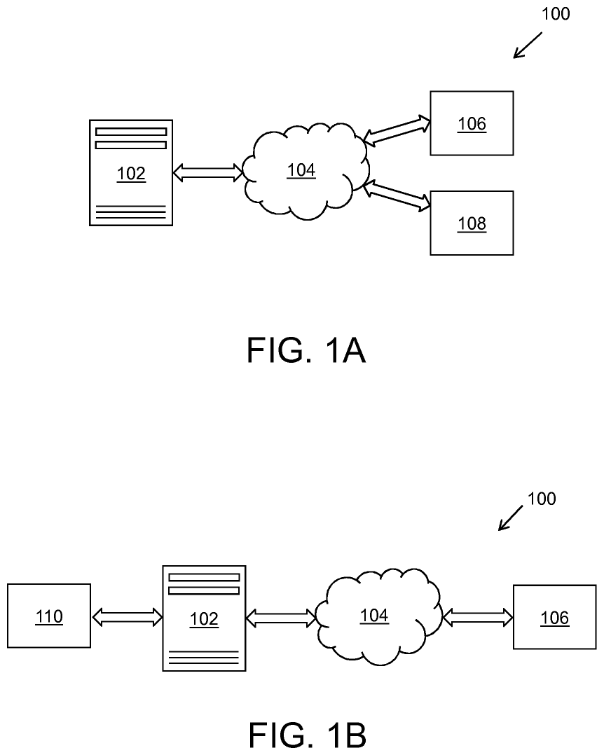

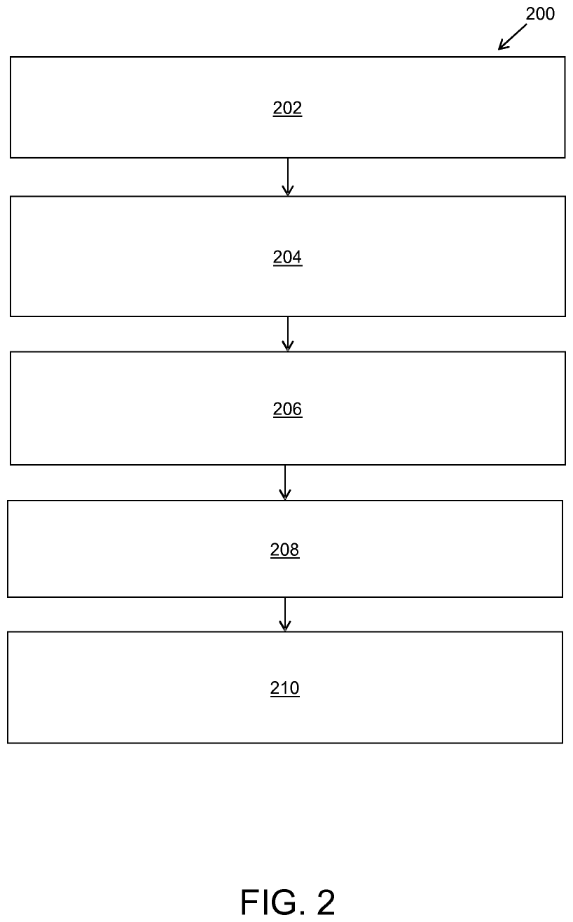

Referring to FIGS. 1A and 1B, illustrated are schematic illustrations of a network environment 100 wherein a system for generating an annotated synthetic training data for a machine learning task is implemented, in accordance with different embodiments of the present disclosure. Notably, the network environment 100 includes: a server arrangement 102 including at least one server, a communication network 104, a user device such as the user devices 106 and 108 associated with a user of the system for providing user input for generating an annotated synthetic training samples for a machine learning task. As shown, in the network environment 100, the server arrangement 102 is coupled in communication with the user device such as the user devices 106 and 108 via the communication network 104.

In an embodiment, as illustrated in FIG. 1B, the server arrangement 102 is further coupled in communication with a database arrangement 110.

It will be appreciated that FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of user devices, servers, sources of input data, and communication networks. A person skilled in the art will recognize many variations, alternatives, and modifications of embodiments of the present disclosure.

Referring to FIG. 2, illustrated are steps of a method 200 of generating an annotated synthetic training data for training a machine learning module for processing an operational data set, in accordance with an embodiment of the present disclosure. At step 202, a first procedural model for an object is created. The first procedural model has a first set of parameters relating to the object. At step 204, a second procedural model is created for a background. The second procedural model has a second set of parameters relating to the background. At step 206, a task environment model is created using the first and the second procedural models. At step 208, a synthetic data is created using the task environment model. In practice this is done by selecting values for the first and second set of parameters and synthesizing the data according to selected parameter values. At step 210, at least one parameter of the first set of parameters is allocated as an annotation for the synthetic data set to generate the annotated synthetic training data.

The steps 202 to 210 are only illustrative and other alternatives can also be provided where one or more steps are added, one or more steps are removed, or one or more steps are provided in a different sequence without departing from the scope of the claims herein.

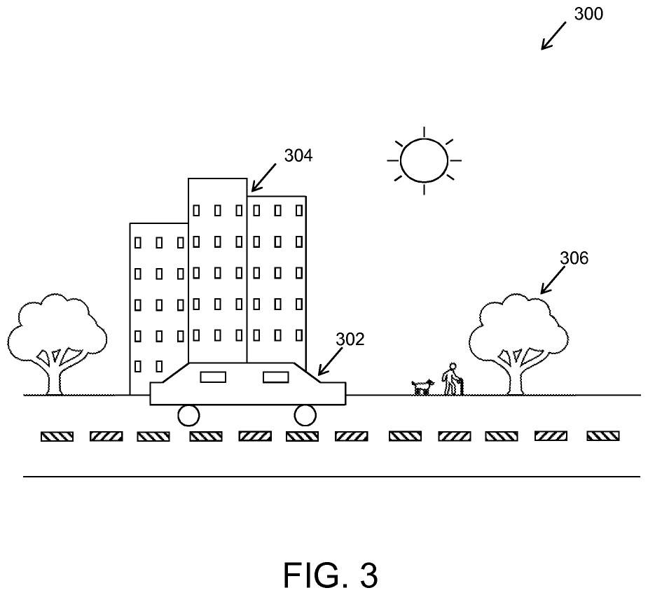

FIG. 3 is a schematic illustration of an exemplary representation of a task environment model 300 employed for generating an annotated synthetic training data for training a machine learning module to find the location of cars from image data, in accordance with an embodiment of the present disclosure. As shown, the task environment model 300 includes an object, i.e. car 302; and background, i.e. building 304 and tree 306. It will be appreciated that the plurality of annotated synthetic training data will be generated from the task environment model 300, the data items containing combinations of the object and the background according to varied parameter values thereof. For example, the annotated synthetic training data may comprise of images with a changed shape of the car 302, dry leaves on tree 306, and the like.

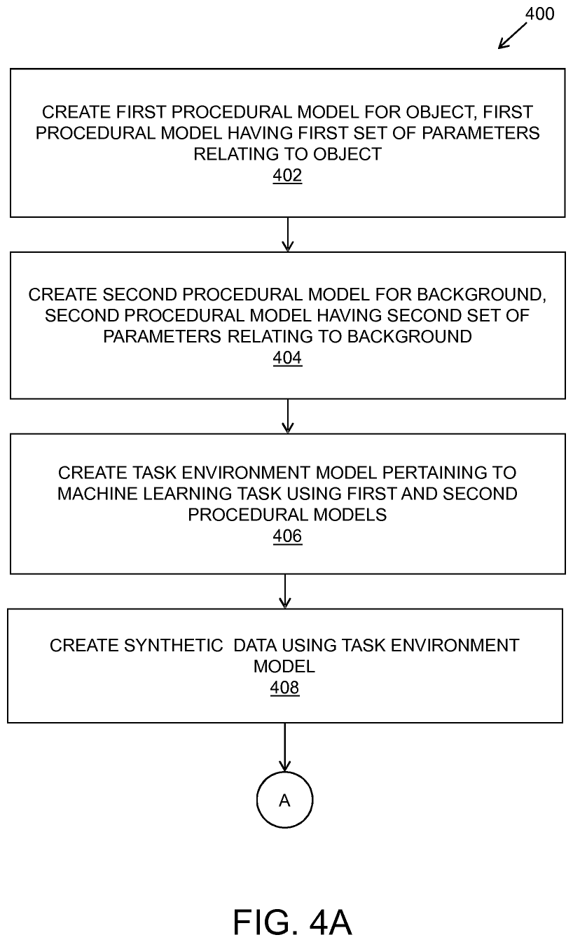

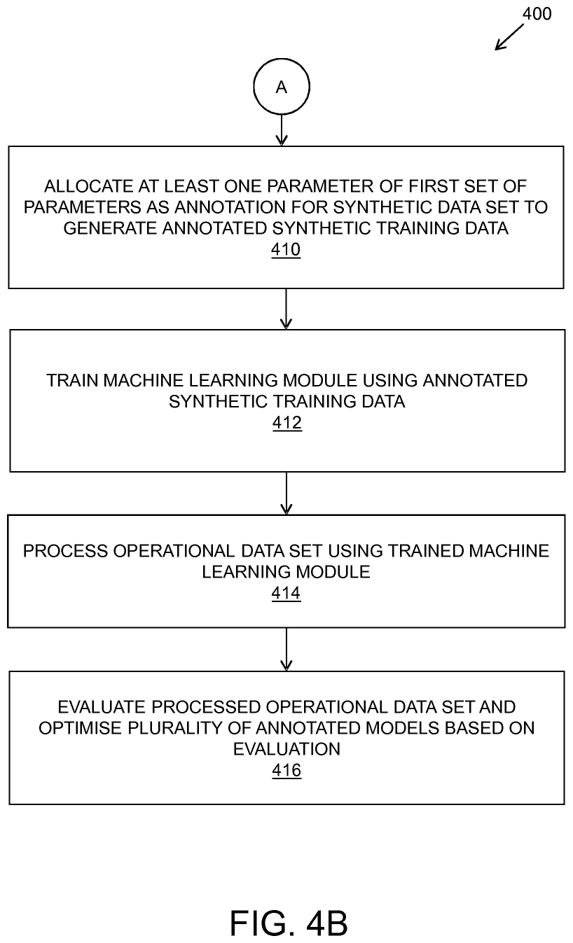

Referring to FIGS. 4A and 4B, illustrated are steps of a method 400 of generating an annotated synthetic training data for training a machine learning module for processing an operational data set, in accordance with an embodiment of the present disclosure. At step 402, a first procedural model for an object is created. The first procedural model has a first set of parameters relating to the object. At step 404, a second procedural model is created for a background. The second procedural model has a second set of parameters relating to the background. At step 406, a task environment model is created using the first and the second procedural models. At step 408, values for the first and second sets of parameters are selected and synthetic data items are created using the task environment model according to selected parameter values. At step 410, at least one parameter of the first set of parameters is allocated as an annotation for the synthetic data set to generate the annotated synthetic training data. At step 412 a machine learning module is trained using the annotated synthetic training data. At step 414 operational data is processed using the machine learning module. At step 416, the performance on the processed operational data is evaluated and the annotated synthetic training data is optimised based on the evaluation. At step 418 further operational data is processed with the machine learning module.

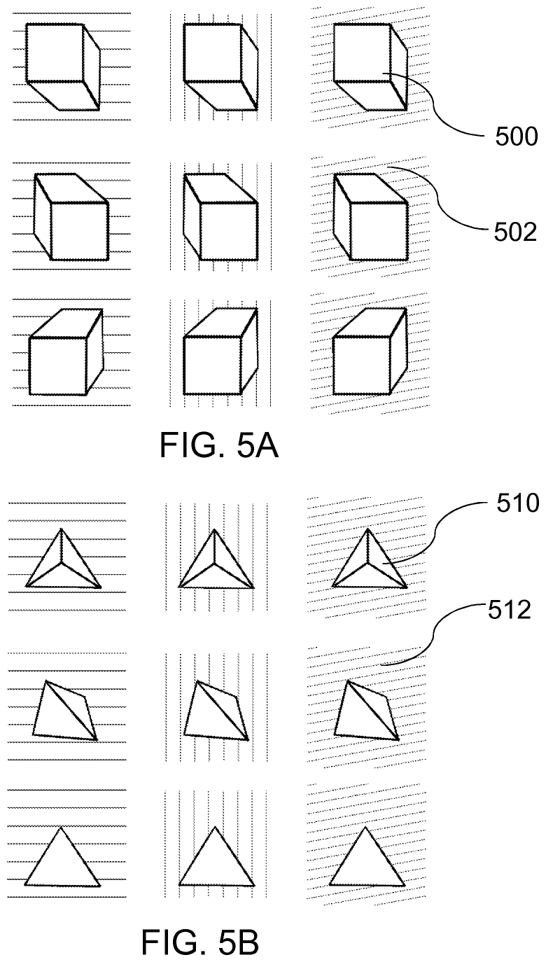

An example of the annotated synthetic training data is given in FIG. 5A and 5B. The machine learning task is to classify images of objects into two classes, a class A with 6 sides and a class B with 4 sides. A first object 500 of type A is a 3D object with 6 sides. A second object 510 of type B is a 3D object with 4 sides. In this case, the first set of parameters comprises the class (class A or B, used as the annotation) and the orientation in the object in an image (three angles). The background 502, 512 consists of parallel lines and the second set of parameters controls the orientation of the lines in the background as shown in the figures. The task environment model combines the first and the second procedural models and as an output of the task environment model, a set of 18 training data items are generated, where three combinations of (viewing) angle parameters are used for the objects from both classes A and B combined with backgrounds corresponding to three values of the background orientation parameter. FIG. 5A is illustration of the images for class A and FIG. 5B illustration of the images of class B. In each image, the rows show the simulated output from the task environment model with the different angle parameter combinations and the columns contain the output with different values of background line orientation parameter. This is an illustrative example of the annotated training data which can be used for training a machine learning module to recognize 6 side objects and 4 side objects in front of different backgrounds from 2D images. The trained module can be used for processing further data items in the operational data set. With sufficient training data, the trained module could classify the object to classes A or B.

FIG. 6 is an illustration of the steps of the method 600 when using Bayesian maximization to optimize the parameters of the task environment model.

The task environment model is first created 602, after which initial values for the parameters relating to the task environment model are selected 604. Then a surrogate model for modelling the impact of the parameters relating to the task environment model to the performance of the machine learning module on operational data (often a Gaussian Process) is selected 606 and an acquisition function is selected 608 for proposing new values of the parameters relating to the task environment model for generating annotated synthetic training data from the surrogate model.

Next annotated synthetic training data from the task environment model is created 610 according to the values of the parameters related to the task environment model selected in step 604 or values contained in the proposal from step 626. The machine learning module is trained using the annotated synthetic training data 612 and the operational data set is processed using the trained machine learning module 614.

After this, evaluating the processed operational data set and optimising the annotated synthetic training data based on the evaluation comprises using cross validation or other performance evaluation techniques to evaluate the performance of the machine learning module on the operational data set 616 and storing the sets of parameter values relating to the task environment model that were used for generating the annotated synthetic training data paired with the performance of the machine learning module on the operational data 618 in computer storage 620.

A decision is made 622 based on the level of performance observed at step 618 and available computational resources, decide to stop either continue (Yes) or stop (No).

If decided to continue, continue to step 624 and update the parameters of the surrogate model according to the stored sets of parameter values relating to the task environment model that were used for generating the annotated synthetic training data and the corresponding performance of the machine learning module on the operational data. Then a proposal is sampled 626 for the values of the parameters relating to the task environment model by using the surrogate model and the acquisition function. The sampled proposal is then used to perform step 610 by using the proposed values for the parameters relating to the task environment model from step and the process continues.

If the performance of the machine learning module is considered sufficient or no more computational resources are available and the decision to stop optimization is made after 622, then the machine learning module is trained 630 with the annotated synthetic training data created according to the stored parameter values (620) relating to the task environment model that give the best performance when evaluated on the operational data.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method of generating annotated synthetic training data for training a machine learning module for processing an operational data set, the method comprising:
(i) creating a first procedural model for an object, the first procedural model having a first set of parameters relating to the object;
(ii) creating a second procedural model for a background, the second procedural model having a second set of parameters relating to the background;
(iii) creating a task environment model using the first procedural model and the second procedural model;
(iv) creating a synthetic data set using the task environment model;
(v) generating the annotated synthetic training data by allocating at least one parameter of the first set of parameters as an annotation for the synthetic data set;
(vi) training the machine learning module using the annotated synthetic training data;
(vii) processing the operational data set using the trained machine learning module;
(viii) evaluating a performance score of the machine learning module when used for processing the operational data set, based on an annotation of the processed operational data set and an output of the machine learning module;
(ix) optimising the annotated synthetic training data using Bayesian maximisation, by modifying values of parameters of the task environment model used when generating the annotated synthetic training data based on the evaluation of the performance score; and
(x) further training the machine learning module using the annotated synthetic training data.

2. The computer-implemented method according to claim 1, wherein the annotated synthetic training data comprises a first set of annotated synthetic data items, wherein each of the first set of annotated synthetic data items are generated by varying at least one of a parameter among the first set of parameters or the second set of parameters.

3. The computer-implemented method according to claim 2, wherein the annotated synthetic training data further comprises a second set of annotated synthetic data items, wherein each of the second set of annotated synthetic data items are generated by varying at least one of a parameter among the first set of parameters, the second set of parameters or a third set of parameters, wherein the third set of parameters relate to creating the synthetic data set from the task environment model.

4. The computer-implemented method according to claim 1, wherein the machine learning module is further trained based upon the set of operational data.

5. The computer-implemented method according to claim 1, wherein processing the operational data set comprises performing at least one of: classification, recognition, segmentation and regression.

6. The computer-implemented method according to claim 1, wherein the first set of parameters relating to the object comprises at least one of: a position of the object in the task environment, an orientation of the object in the task environment, a shape of the object, a colour of the object, a size of the object, a texture of the object.

7. The computer-implemented method according to claim 1, wherein the second set of parameters relating to the background comprises at least one of: elements in the background, a position of the elements in the background, orientation of the elements in the background, shape of the elements, a colour of the elements, a size of the elements, a texture of the elements.

8. The computer-implemented method according to claim 1, wherein the third set of parameters relating to the creating the synthetic data set for the task environment model comprises at least one of: point of view, illumination level, zoom level, camera settings.

9. The computer-implemented method according to claim 1, wherein selecting the parameter values for the first, second and third set of parameters is based on at least one of: principles of experimental design.

10. The computer-implemented method according to claim 1, wherein at least one of a parameter from among the first set of parameters and the second set of parameters is varied based upon at least one of: the object and the background.

11. A system for generating an annotated synthetic training data for training a machine learning module for processing an operational data set, the system comprising a server arrangement that is configured to:
(A) create a first procedural model for an object, the first procedural model having a first set of parameters relating to the object;
(B) create a second procedural model for a background, the second procedural model having a second set of parameters relating to the background;
(C) create a task environment model using the first procedural model and the second procedural model;
(D) create a synthetic data set using the task environment model;
(E) generate the annotated synthetic training data by allocating at least one parameter of the first set of parameters as an annotation for the synthetic data set;
(F) train the machine learning module using the annotated synthetic training data;
(G) process the operational data set using the trained machine learning module;
(H) evaluate a performance score of the machine learning module when used for processing the operational data set, based on an annotation of the processed operational data set and an output of the machine learning module;
(I) optimise the annotate synthetic training data using Bayesian maximisation, by modifying values of parameters of the task environment model used when generating the annotated synthetic training data based on the evaluation of the performance score; and
(J) further train the machine learning module using said annotated synthetic training data.

12. (canceled)

13. The system according to claim 11, wherein the server arrangement is further configured to train the machine learning module based upon a combination of the annotated synthetic training data and a set of operational data.

14. The system according to claim 11, wherein processing the operational data set comprises performing at least one of: classification, recognition, segmentation, object detection and regression.

15. The system according to claim 11, wherein the server arrangement is further configured to select the values of the parameters of at least one of the first procedural model for the object and the second procedural model for the background based on at least one principle of design of experiments.

16. The system according to claim 11, wherein at least one of a parameter from among the first set of parameters and the second set of parameters is varied based upon at least one of the object and the background.

17. The system according to claim 11, wherein the annotated synthetic training data comprises a set of annotated synthetic data items, wherein each of the annotated synthetic data items are generated by varying at least one of a parameter among the first set of parameters or the second set of parameters.

18. The system according to claim 11 wherein the allocated annotation for the synthetic data set is a metadata associated with the first procedural model for the object, and the created first procedural model for the object is 3D graphical object.

19. The system according to claim 11, where the system is configured to communicate the results of processing the operational data with the machine learning module as a visual output or via an communication interface.
